(19) United States
(12) Patent Application Publication
(10) Pub. No.: US 2024/0334881 A1
(43) Pub. Date: Oct. 10, 2024

(54) COMBINATION, METHOD FOR OPERATING A COMBINATION, AND BALER

(71) Applicant: DEERE & COMPANY, MOLINE, IL (US)

(72) Inventors: PIERRE DOMMANGE, MAIZIERES LES METZ (FR); LIONEL GUIET, GRAY (FR)

(21) Appl. No.: 18/581,029

(22) Filed: Feb. 19, 2024

(30) Foreign Application Priority Data
Apr. 6, 2023 (DE) 102023108812.2

(51) Int. Cl. A01F 15/08; A01B 69/04

(52) U.S. Cl. CPC A01F 15/0883; A01B 69/008

(57) ABSTRACT

A combination of a towing vehicle and a baler includes a control unit which is connected to an actuator. The actuator is specified to adjust and/or set an angle between a drawbar and the baler. The control unit, as a function of an unloading signal, is able to be operated so as to actuate the actuator in such a manner that, for unloading a fully formed or fully wrapped bale from the baler in a specified direction, an unloading angle between the drawbar and the baler is able to be set in such a way that the bale is able to be ejected from the baler in the specified direction.

### CROSS-REFERENCE TO RELATED APPLICATIONS

This application claims the benefit of German Patent Application DE102023108812.2, filed on Apr. 6, 2023, the disclosure of which is hereby incorporated by reference.

### TECHNICAL FIELD

The disclosure generally relates to a combination of a towing vehicle and a baler implement, and a method of operating the combination.

### BACKGROUND

Balers, in particular round balers or square balers, are used for picking up and compressing crop, for example straw, hay or the like. For this purpose, the baler may comprise a pick-up unit for picking up the crop, in particular for picking up the crop from a swath. In this instance, the crop lying on the ground can be picked up by the pick-up unit, in particular a pick-up. The baler can also comprise a bale chamber. The bale chamber can comprise one or a plurality of pressing means. The bale chamber can receive the crop picked up by the pick-up unit and compress it into a bale. The baler can moreover comprise a conveying unit. The crop picked up by the pick-up unit can be guided into the bale chamber by means of the conveying unit, for example a rotor. The conveying unit can be designed as part of the pick-up unit or be disposed downstream of the pick-up unit, in particular disposed downstream in the conveying direction. The bale, in particular the round bale or the square bale, is formed in the bale chamber. The fully formed bale can then be wrapped in the bale chamber with a wrapping material, for example a mesh, film or twine. The fully formed bale or the fully wrapped bale can be unloaded or ejected via an ejection unit, for example an ejection flap or a rear part or a tailgate of the baler, in particular via the bale chamber provided with an ejection unit.

Disadvantages of unloading or ejecting the fully formed or wrapped bale from the baler include that the bale using known combinations or balers is able to be unloaded only along a longitudinal central axis of the baler and/or is not able to be unloaded at a position desired by an operator of the combination and/or in the desired direction and/or that the bale can roll away after ejection. In addition, when the combination travels along a swath, it is not possible to unload the bale in a direction that can be specified in relation to the swath, in particular at an angle specified in relation to the swath, without stopping the combination and maneuvering in the desired direction. Typically, after a bale is fully formed or fully wrapped, the operator has to steer and/or drive the combination to the desired position and/or in the desired direction and align the baler in a laborious manner in order to be able to eject the bale at the position desired by the operator and/or in the desired direction.

### SUMMARY

Proposed according to the disclosure is a combination of a towing vehicle and a baler which is pulled by the towing vehicle by means of a drawbar. The combination comprises a control unit which is connected to an actuator. The actuator is specified, and/or in particular designed, to adjust and/or set an angle between the drawbar and the baler. In other words, an angle between the drawbar and the baler can be able to be set and/or adjusted by the actuator. Moreover, the baler can be able to be controlled and/or set and/or adjusted, in particular able to be steered and/or pivoted, by the actuator in a lateral direction in relation to the towing vehicle, thus in particular horizontally and transversely to a longitudinal central axis of the baler. The control unit as a function of an unloading signal is able to be operated so as to actuate the actuator in such a manner that, for unloading a bale, in particular a completely formed or completely wound bale, from the baler in a specifiable or specified direction, an unloading angle between the drawbar, in particular a longitudinal central axis of the drawbar, and the baler, in particular a longitudinal central axis of the baler, is set or able to be set in such a way that the bale is able to be ejected from the baler in the specified direction, and in particular at the unloading angle. In other words, the actuator can be able to be actuated by the control unit as a function of the unloading signal in such a manner that, for unloading the bale from the baler in a specifiable or specified direction, an unloading angle between the drawbar, in particular a longitudinal central axis of the drawbar, and the baler, in particular a longitudinal central axis of the baler, is set or able to be set in such a way that the bale is able to be ejected from the baler in the specified direction, and in particular at the unloading angle. In particular, the actuator as a function of the unloading signal can be able to be actuated by the control unit in such a manner, and in particular the unloading angle able to be determined, preferably calculated, and set, by the control unit in such a manner that the bale is able to be ejected from the baler in a specified direction and/or at a specified angle in relation to a target line of the swath, in particular a longitudinal central axis of the swath.

The towing vehicle can be an agricultural towing vehicle, in particular a tractor or a hauler. The towing vehicle can be arranged in front of the baler in a direction of travel. The towing vehicle can pull the baler. The towing vehicle can moreover comprise a steering installation for steering the towing vehicle. The towing vehicle can comprise a drive system for driving the towing vehicle. The towing vehicle, in particular the drive system, can comprise a drive motor, for example an internal combustion engine or an electric motor. The towing vehicle, in particular the drive system, can comprise a transmission unit, in particular a gearbox. The drive system and/or its components, for example the drive motor and/or the gearbox, can be connected to the control unit and/or be able to be controlled, in particular set and/or adjusted. The towing vehicle can be able to be driven or be driven by or with the drive system, in particular the drive motor. In particular, one or a plurality of ground-engagement means of the towing vehicle can be connected, in particular be operatively connected for driving and/or be mechanically coupled, directly or by way of the drive system, for example via the transmission unit to the drive motor. The ground-engagement means can be able to be driven by the drive system, in particular the drive motor and/or gearbox, in such a manner that the towing vehicle is able to be moved in a forward and/or reverse direction, for example. In addition, the drive motor can be connected, in particular operatively connected for driving and/or mechanically coupled, to a drive shaft of the baler. As a result, the drive motor can transmit a rotating speed and/or a torque to the baler via the drive shaft. The baler can be connected, in particular mechanically connected and/or mechanically coupled, to the towing vehicle via the drive shaft and/or via a towing device, for example the drawbar and/or a coupling. In particular, the towing vehicle and the baler can be connected to one another, in particular coupled and/or mechanically connected to one another, by means of the drawbar. For example, a towing vehicle frame of the towing vehicle can be connected to a baler frame of the baler via the or with the towing device. The towing vehicle can comprise the towing vehicle frame. The towing vehicle may include the one or more ground-engagement means. The ground-engagement means can support and/or carry the towing vehicle on the ground. The towing vehicle frame of the towing vehicle can be supported by front and rear wheels. The ground-engagement means can be wheels or tracks or chains. The ground-engagement means, in particular the front wheels and rear wheels, may be steerable and/or movable. The towing vehicle, in particular the drive system, can comprise at least one front axle and at least one rear axle. At least one of the two axles can be able to be driven, or be driven. At least one of the two axles, in particular the front axle, can be steerable, preferably by a steering installation, particularly preferably be able to be actuated and/or set and/or adjusted by a steering actuator. Likewise, the front axle and/or the rear axle can be steerable. The steering actuator may be designed, for example, in the form of a hydraulic cylinder or pneumatic cylinder or threaded drive or rack-and-pinion mechanism or electric cylinder. In particular, the towing vehicle can comprise a steerable front axle and front and/or rear wheels that are able to be driven by the drive system.

The baler can be a square baler for forming square bales, or a round baler for forming round bales from crop. The baler can comprise a baler frame. The baler can also be integrated in the towing vehicle, i.e. the combination can be designed as a self-propelled baler. The baler can be supported on the ground by wheels. The baler can comprise a baling system for forming bales, in particular in a pressing phase. The baler, especially the baling system, can comprise the pick-up unit, especially a pick-up, for picking up crop, in particular for picking up the crop from a swath. The baler, especially the baling system, can also comprise a bale chamber. The bale chamber can comprise one or a plurality of pressing means. The baler can moreover comprise a conveyor unit, for example a rotor or a conveyor belt. The bale can be formed by the baling system, in particular by the bale chamber, in particular in a pressing phase. The baler, in particular the baling system, can comprise a wrapping installation for wrapping the fully formed bale with a wrapping material, for example a mesh, film or twine. The fully formed bale can be wrapped with the wrapping material, in particular in the bale chamber. The baler can comprise an ejection unit, for example an ejection flap or a rear part or a tailgate of the baler. The fully formed bale or the fully wrapped bale can be unloaded or ejected via the ejection unit of the baler, in particular via the bale chamber provided with the ejection unit. The baler can be designed with a variable-size bale chamber or as a baler with a variable bale chamber. The baler with a variable-size bale chamber can comprise one or a plurality of pressing means, wherein the pressing means can be designed in particular as a belt or strap or chain assembly or band. The baler can equally also comprise a size-invariable bale chamber. In this instance, a pressing means can be designed as a pressing roller, in particular a multiplicity of pressing rollers running parallel to one another, for compressing the crop. The axes of rotation of the pressing rollers can lie on an arc in the case of a closed ejection unit, and at least one of the pressing rollers can be driven. The arrangement of the pressing rollers in the bale chamber can correspond to a cylindrical shape, such that the pressing rollers are disposed cylindrically about the round bale and form a cylindrical circumferential face. The bale chamber can be disposed on the baler frame, preferably be connected to the latter and/or fastened to the latter. The pick-up unit for picking up or for collecting crop lying or standing on a field, and/or for transporting the crop into the bale chamber can likewise be disposed on the baler frame, preferably connected to the latter and/or fastened to the latter.

In particular, the actuator, in particular a first actuator, can be designed and/or specified for setting and/or adjusting an angle between the drawbar, in particular the longitudinal central axis of the drawbar, and the baler, in particular the longitudinal central axis of the baler. In other words, by way of the actuator, an angle between the drawbar and the baler can be able to be set and/or adjusted. The control unit can be connected to the actuator via a valve assembly, in particular a first valve assembly. The actuator can be designed, for example, in the form of a hydraulic cylinder or pneumatic cylinder or lifting cushion or threaded drive or rack-and-pinion mechanism or electric cylinder. The actuator at one end, for example by way of the piston, can be connected to, in particular be pivotably fastened to or articulated on, the drawbar, and at the other end, for example by way of the cylinder, be connected to, in particular be pivotably fastened to or articulated on, the baler, for example the baler frame. Likewise, the actuator may also be connected to the drawbar and the baler in a reversed arrangement. The baler can moreover comprise one or a plurality of feedback sensors. The feedback sensor can be connected to the control unit and inform the control unit about the angle, in particular the current angle, between the drawbar and the baler, particularly between the longitudinal central axes of the latter two. Likewise, the control unit can also however evaluate or calculate the angle by way of the position of the actuator, in particular of the piston, in relation to the cylinder, for example by determining the length of the deployed piston.

The unloading signal can be manually generated by the operator using an input and output unit and sent to the control unit or be generated by the control unit, for example: before the pressing phase is completed, for example a few seconds before, or once the pressing phase is completed. The end of the pressing phase or the pressing procedure can be present when the bale is fully formed, i.e. for example when it has reached a desired size (for example diameter, radius, volume). During or before a wrapping phase is completed, for example a few seconds before, or once the wrapping phase is completed. The completion of the wrapping phase or the wrapping procedure can be present when the bale is fully wrapped with wrapping material. Before or while the ejection unit of the baler opens.

The baler, in particular the baling system, can comprise one or a plurality of bale sensors for detecting a size of the bale, for example a volume or diameter or a radius of the bale, and/or a tension of the pressing means and/or a distribution of the crop, in particular a lateral distribution of the crop. The bale sensor(s) can sense the size of the bale and/or a tension of the pressing means or a distribution of the crop in the form of a bale signal. The bale sensor(s) can be disposed on or in the baling system, in particular on or in the bale chamber and/or the pick-up unit. The bale sensor(s) can be distributed, for example, over a width of the bale chamber and/or the pick-up unit in order to obtain in particular a uniform distribution of the crop in the bale chamber and thus uniformly shaped bales. The bale sensor(s) can be connected to the control unit. The bale signal can be transmitted by the bale sensor(s) to the control unit, or be received by the control unit from the bale sensor(s), respectively. The control unit can generate the unloading signal if the control unit uses the bale signal to evaluate that the size of the bale has reached a specified size, i.e. a target size, i.e. the size of the bale≥a target size. Likewise, the control unit can evaluate by way of the bale signal that the tension of the pressing means has reached a specified target tension, i.e. in particular the tension≥a target tension, and/or the distribution of the crop has reached a specified target distribution, and thus the bale has reached specified size. If the bale has reached a specified size, i.e. reached the target size or the target tension or a target distribution, the pressing phase or the pressing procedure can be completed. Specifically, the control unit can generate the unloading signal as a function of the bale signal just before the bale phase is completed, for example a few seconds before, or once the pressing phase is completed.

The baler, especially the baling system, can comprise one or a plurality of wrapping sensors to detect the state or status of the wrapping of the bale, for example an ultrasonic sensor and/or a sound sensor and/or camera. Likewise, the wrapping sensor can however also detect the length of the unrolled wrapping material. The wrapping sensor(s) can sense the state or status of the wrapping of the bale in the form of a wrapping signal. The wrapping sensor(s) can be disposed on or in the baling system and/or on or in the bale chamber. The wrapping sensor(s) can be connected to the control unit. The wrapping signal can be transmitted by the wrapping sensor(s) to the control unit or received by the control unit from the wrapping sensor(s). In particular, the control unit can generate the unloading signal as a function of the wrapping signal. The control unit can generate the unloading signal when the control unit receives the wrapping signal, or when the control unit by way of the wrapping signal has evaluated or calculated that the bale is fully wrapped. The control unit can evaluate the status of the wrapping phase and/or the completion of the wrapping phase by way of the wrapping signal. However, the wrapping signal can likewise also indicate the completion of the wrapping phase. The status of the wrapping phase can be during the wrapping phase or just before the wrapping phase is completed, for example a few seconds before, or the wrapping phase can be completed. The control unit can generate the unloading signal as a function of the status, i.e. during the wrapping phase or shortly before the wrapping phase is completed, for example a few seconds before, or the wrapping phase is completed. The end of the wrapping phase or the wrapping procedure can be present when the bale is fully or completely wrapped with wrapping material.

The control unit is able to be operated as a function of the unloading signal, thus in particular when the control unit receives or generates the unloading signal, or the actuator is able to be actuated by the control unit as a function of the unloading signal in such a manner that an unloading angle between the drawbar and the baler is able to be set. The angle between the drawbar and the baler can be evaluated in particular by means of or using the longitudinal central axis of the drawbar and the longitudinal central axis of the baler. For example, the angle or the unloading angle can be evaluated based on a position or length of the actuator, in particular a length of the deployed piston, in particular in the form of a look-up table, and/or the feedback sensor(s) evaluate the angle in the form of an angle signal. The control unit can set and/or adjust the angle to the unloading angle using the actuator. The actuator and/or the feedback sensor(s) can confirm the set unloading angle to the control unit. In a first embodiment, the angle between the drawbar and the baler can thus be able to be set in such a manner that this angle corresponds to the unloading angle. Likewise, the angle between the drawbar and the baler can also be set or able to be set in such a manner that the unloading angle between the drawbar and the baler is able to be set as a function of or in relation to the target line of the swath. The target line of the swath herein can correspond in particular to a longitudinal central axis of the swath. The unloading angle can result from the difference of the angles between the baler, in particular the longitudinal central axis of the baler, and the target line of the swath, in particular the longitudinal central axis of the swath, and between the drawbar, in particular the longitudinal central axis of the drawbar, and the target line of the swath, in particular the longitudinal central axis of the swath. The unloading angle in this instance is derived as follows:

$$EW = \vert WB - WD \vert$$

Wherein:
EW=Unloading Angle
WB=Angle between baler and target line of the swath
WD=Angle between drawbar and target line of the swath

In this way it can advantageously be achieved by the combination or the baler, respectively, that the bale is able to be unloaded not only along a longitudinal central axis of the baler but in a specified direction and/or position and/or angle, in particular specified by the operator. It is furthermore advantageous that the bale can thus be deposited in such a way that the bale cannot roll away after ejection and/or lies in a specified and advantageous position for collecting the bales. In particular, the bale can also be advantageously laid down in relation to the target line of the swath.

In one embodiment of the disclosure, the combination, in particular the baler, comprises one or a plurality of inclination sensors for detecting the inclination in the form of an inclination signal. The inclination sensor is connected to the control unit. The control unit receives the inclination signal from the inclination sensor, and/or the inclination sensor sends the inclination signal to the control unit. The control unit is able to be operated in such a manner that the unloading angle and/or an unloading position of the combination, in particular of the baler, is able to be determined and/or evaluated, thus in particular able to be calculated, using or by the control unit as a function of the inclination signal. In other words, the control unit can be able to be operated in such a manner that the control unit can determine and/or evaluate the unloading angle and/or the unloading position by way of the inclination signal. This can also be understood to mean that the control unit transmits the inclination signal with a radio module to a central server and the central server can determine and/or evaluate the unloading angle and/or the unloading position and the central server transmits the unloading angle and/or the unloading position to the control unit. The inclination can be understood here to be, for example, the lateral inclination of the ground or a slope inclination at the position at which the combination, in particular the towing vehicle and/or the baler, stands. In this context, the lateral inclination of the ground or the slope inclination can be the angle of inclination between a slope surface and the horizontal. If the unloading angle is evaluated as a function of the inclination, the inclination can be balanced so that the bale does not roll down a slope. However, the unloading angle can also be evaluated or specified in such a way that the specified angle to a target line of the swath is observed. Advantageously, as a result the unloading angle and/or the unloading position can be evaluated by way of the inclination of the ground and the bale can be unloaded safely and at the specified position. Moreover, the bale can be deposited in such a manner, in particular in relation to the swath, that it can be collected quickly and with a short collection path in a subsequent collection procedure, i.e. when the bale is collected from the field.

In a design embodiment of the disclosure, the combination comprises one or a plurality of GPS installations for determining the position of the combination, in particular of the towing vehicle and/or the baler, in the form of a position signal. The control unit is connected to the GPS installation. The control unit receives the position signal from the GPS installation and/or the GPS installation sends the position signal to the control unit. The control unit is able to be operated in such a manner that a, or the, unloading angle and/or a or the unloading position is able to be determined and/or evaluated, thus in particular calculated, using or by the control unit as a function of the position signal. In other words, the control unit can be able to be operated in such a manner that the control unit can determine and/or evaluate the unloading angle and/or the unloading position by way of the position signal. This can also be understood to mean that the control unit transmits the position signal with the radio module to a central server and the central server can determine and/or evaluate the unloading angle and/or the unloading position, and the central server transmits the unloading angle and/or the unloading position to the control unit. With the GPS installation, a position or the position signal can be able to be sent and/or received, and/or in particular be calculated. The GPS installation can comprise, for example, a GPS antenna and a memory. The position of the combination, in particular of the towing vehicle and/or the baler, can be stored in the memory. Likewise, a position of the swath or the target line of the swath, which may be known, for example, from previous tilling procedures on the swath, can be stored. The unloading position can be evaluated in such a manner, for example, that the unloading position of the combination, in particular of the towing vehicle and/or the baler, is not on a slope or parallel to the slope, for example, thus ensuring that the bale does not roll down the slope. However, the unloading position can also be evaluated or specified in such a manner that the specified unloading position is maintained, in particular also maintained in relation to a target line of the swath. It is thereby advantageously possible to evaluate the unloading angle and/or the unloading position in accordance with the position of the combination, in particular of the towing vehicle and/or the baler, and to unload the bale reliably and at the specified position. In addition, the bale can be deposited in such a manner that it can be collected quickly and with a short collection path in a subsequent collection procedure, i.e. when the bales are collected from the field.

In a design embodiment of the disclosure, the combination, in particular the towing vehicle and/or the baler, comprises one or a plurality of steering installations. The combination, in particular the towing vehicle and/or the baler, can however also comprise a steering controller, which can be connected to the steering installation. The control unit is connected to the steering installation. Likewise, the control unit may be connected to the steering controller, or the steering controller can be designed as a part or component of the control unit. The control unit is able to be operated as a function of the unloading signal so as to control the steering installation in such a manner that the combination, in particular the towing vehicle and/or the baler, is able to be steered by the steering installation, in particular able to be steered to the unloading position. In other words, the steering installation is able to be actuated by the control unit in such a manner that the combination, in particular the towing vehicle and/or the baler, is able to be steered as a function of the unloading signal, in particular is able to be steered to the unloading position. However, the control unit as a function of the unloading signal can also be able to be operated so as to actuate the drive system, in particular the drive motor and/or the transmission unit, in such a manner that the combination, in particular the towing vehicle and/or the baler, are/is able to be steered, in particular driven, to the unloading position by the drive system. In other words, the drive system can be able to be actuated by the control unit in such a manner that the combination, in particular the towing vehicle and/or the baler, are/is able to be controlled, in particular driven, to the unloading position as a function of the unloading signal. In particular, the combination, particularly the towing vehicle and/or the baler, can comprise one or a plurality of detection installations, for example in the form of a camera. The detection installation can, for example, be disposed or attached on the front and/or rear of the towing vehicle and/or the front and/or rear of the baler. The detection installation can detect, in particular visually detect, the swath in the form of a detection signal, for example an image, a video signal or a distance. The detection installation can be connected to the control unit and/or to an image processing system. The detection installation can send the detection signal to the control unit and/or the image processing system. The image processing system can determine a target line of the swath, in particular the longitudinal central axis of the swath. Likewise, the image processing system can send a steering signal to the steering controller of the combination and/or the control unit, or the control unit and/or the steering controller can receive the steering signal. Likewise, the control unit or the steering controller can generate or produce a steering signal as a function of the sensing signal or of the target line of the swath.

The steering installation can comprise the steering controller and a steering actuator. The steering actuator can, for example, be a hydraulic cylinder or pneumatic cylinder or lifting cushion or threaded drive or rack-and-pinion mechanism or electric cylinder by way of which the front and/or rear axle and/or the ground-engagement means, in particular the front wheels, are able to be adjusted and/or set. The steering installation, in particular the steering actuator, can actuate, in particular set and/or adjust, the front and/or rear axle and/or the ground-engagement means by the steering controller and/or the control unit in such a manner that the towing vehicle, in particular the longitudinal central axis of the towing vehicle, is steered and/or controlled, in particular automatically, as a function of the steering signal. The steering installation, in particular the steering actuator, can actuate, in particular set and/or adjust, the front and/or rear axle and/or the ground-engagement means by the steering controller and/or the control unit in such a manner that the towing vehicle, in particular the longitudinal central axis of the towing vehicle, is guided at least approximately on the target line of the swath, which corresponds to the longitudinal central axis of the swath, as a function of the steering signal. Likewise, the steering installation, in particular the steering actuator, can actuate, in particular set and/or adjust, the ground-engagement means, in particular the steerable front wheels of the towing vehicle, by the steering controller and/or the control unit in such a manner that the combination, in particular the towing vehicle and/or the baler, is able to be steered to the unloading position by the steering installation, in particular as a function of the unloading signal and/or steering signal. As a result, the combination can advantageously be automatically guided, in particular to the unloading position.

In a design embodiment of the disclosure, the combination, in particular the towing vehicle, comprises an input and output unit. The control unit is connected to the input and output unit, wherein an unloading signal is able to be generated and transmitted, in particular sent, to the control unit by the input and output unit, and/or the unloading signal is able to be received by the control unit. For example, using the input and output unit, the operator of the combination can trigger the unloading signal at the push of a button or by means of a voice command. Advantageously, this allows the operator of the combination to generate the unloading signal manually.

In a design embodiment of the disclosure, the unloading signal can be generated by the control unit, before the pressing phase is completed, for example a few seconds before, or once the pressing phase is completed. The end of the pressing phase or the pressing procedure can be present when the bale is fully formed, i.e. for example when it has reached a desired size (for example diameter, radius, volume). During or before a wrapping phase is completed, for example a few seconds before, or once the wrapping phase is completed. The completion of the wrapping phase or the wrapping procedure can be present when the bale is fully wrapped with wrapping material. Before or while the ejection unit of the baler opens.

As a result, the unloading signal can advantageously be generated automatically. Moreover, the unloading position can be approached without time loss, and the unloading angle can be set, as a result.

In a design embodiment of the disclosure, the control unit is able to be operated so as to control the combination, in particular an ejection unit of the baler, in such a manner that the bale, in particular the fully pressed or fully wrapped bale, is ejected when the unloading angle and/or the unloading position is set, in particular the combination has reached the unloading position and the unloading angle is set. In other words, the combination, in particular the ejection unit of the bale, can be able to be controlled by the control unit in such a manner that the bale is ejected when the unloading angle and/or the unloading position is set. Likewise, the combination, in particular the towing vehicle, can comprise the input and output unit, and the control unit can be connected to the input and output unit. An ejection signal can be able to be generated and sent to the control unit by means of or by the input and output unit. However, the control unit can likewise also generate the ejection signal when the unloading angle and/or the unloading position is set. The control unit can be able to be operated as a function of the ejection signal, in particular as a function of the reception of the ejection signal, so as to control the combination, in particular the ejection unit, in such a manner that the bale can be ejected when the unloading angle and/or the unloading position is set, in particular when the combination has reached the unloading position and/or the unloading angle is set. The combination, in particular the baler, can comprise another actuator, for example a second actuator. The other actuator can be designed and/or specified for setting and/or adjusting the ejection unit, for example an ejection flap or a rear part or a tailgate of the baler. The ejection unit of the baler can be able to be set and/or adjusted by the further actuator. The control unit can be connected to the other actuator via the valve assembly or another or second valve assembly. The further actuator can be designed, for example, in the form of a hydraulic cylinder or pneumatic cylinder or lifting cushion or threaded drive or rack-and-pinion mechanism or electric cylinder. The actuator may be connected, in particular be attached and/or articulated, at one end, for example with the piston, to the ejection unit and at the other end, for example, with the cylinder, on the baler, for example, on the baler frame. The actuator can equally also be fastened or articulated the other way around. In other words, the combination, in particular the other actuator, can be able to be controlled with the control unit such that the ejection unit is movable between a first position, in which the bale chamber is closed, in particular the ejection unit closes the bale chamber, and a second position, in which the bale chamber is open, in particular the ejection unit does not close the bale chamber, and the bale can be ejected, preferably when the unloading angle and/or the unloading position is set. This means that the bale can be ejected when the ejection unit is in the second position and the unloading angle is preferably set and/or the combination has reached the unloading position. The ejection unit can be activated manually. For example, at the push of a button, the operator can use the input and output unit to generate the ejection signal when the unloading angle is set, or when the combination has reached the unloading position and the unloading angle is set. The ejection signal can be sent to the control unit and the control unit can actuate the other actuator as a function of this signal in such a manner that this ejection unit moves to the second position. However, the combination can likewise also be automatically unloaded or the ejection unit can be opened automatically in that the control unit generates the ejection signal when the unloading angle is set or when the combination has reached the unloading position and the unloading angle is set, and the control unit drives the other actuator as a function of the ejection signal, in such a manner that the ejection unit is moved to the ejection position. Advantageously, the opening of the ejection unit and the unloading of the bale can be performed manually and/or automatically as a result.

In a design embodiment of the disclosure, the combination, in particular the towing vehicle, comprises an input and output unit. The control unit is connected to the input and output unit, wherein a confirmation signal can be generated by means of or by the control unit when the unloading angle is set, or when the combination has reached the unloading position and the unloading angle is set. The confirmation signal can be sent from the control unit to the input and output unit and is able to be emitted by the input and output unit. The input and output unit can emit the confirmation signal, for example, as a beep or visually on a display of the input and output unit. As a result, a manual unloading mode can advantageously be implemented.

The disclosure further relates to a method for the operation of, or operating, a combination of a towing vehicle and a baler pulled by the towing vehicle by means of a drawbar, wherein an angle between the drawbar and the baler is set and/or adjusted by an actuator. The baler can be steered and/or pivoted laterally in relation to the towing vehicle by the actuator. According to the disclosure, an unloading angle between the drawbar, in particular the longitudinal central axis of the drawbar, and the baler, in particular a longitudinal central axis of the baler, is set and/or adjusted by the actuator as a function of an unloading signal, in order to unload a fully formed or fully wrapped bale from the baler in a specified direction, in such a way that the bale is ejected from the baler at the unloading angle. In a design embodiment of the disclosure, the inclination of the combination is detected in the form of an inclination signal, and the unloading angle and/or an unloading position can be determined and/or evaluated as a function of the inclination signal. For this purpose, the combination can comprise an inclination sensor, wherein an inclination of the combination is detected in the form of an inclination signal by the inclination sensor. As a function of the inclination signal, the control unit can determine and/or evaluate, in particular detect and/or calculate, the unloading angle and/or the unloading position using or as a function of the inclination signal. In a design embodiment of the disclosure, the position of the combination can be detected in the form of a position signal, and an unloading angle and/or an unloading position can be determined and/or evaluated as a function of the position signal. For this purpose, the combination can include a GPS installation, wherein the position of the combination in the form of a position signal is detected and/or evaluated by the GPS installation. As a function of the position signal, the control unit can determine and/or evaluate, in particular detect and/or calculate, the unloading angle and/or the unloading position. The combination can also comprise a steering installation, wherein the combination, in particular the towing vehicle, is controlled or steered to the unloading position as a function of the unloading signal, by the steering installation. The unloading signal is generated before a pressing phase is completed, or when the pressing phase is completed, or during or before a wrapping phase is completed, or when the wrapping phase is completed. The method has all the advantages of the above-mentioned combination according to the disclosure.

The disclosure furthermore relates to a baler. The baler can comprise a drawbar for pulling the baler by a towing vehicle. Furthermore, the baler can comprise a control unit or a baler control unit which is connected to an actuator, wherein the actuator is specified, and/or in particular designed, to adjust and/or set an angle between the drawbar and the baler. As a result, the baler can be able to be steered and/or pivoted in a lateral direction in relation to the towing vehicle. The control unit or baler control unit as a function of an unloading signal is able to be operated so as to actuate the actuator in such a manner that, for unloading a fully formed or fully wrapped bale from the baler in a specified direction, an unloading angle between the drawbar and the baler is able to be set in such a way that the bale is able to be ejected from the baler in the specified direction, in particular at the unloading angle.

The actuator and/or the other actuator(s) and/or the inclination sensor and/or the GPS installation and/or the steering installation and/or the steering actuator and/or the input and output unit and/or the detection installation and/or the image processing system and/or all other sensors, for example the bale sensor(s), wrapping sensors, ejector flap sensor and/or feedback sensors can be able to be operated, preferably actuated and/or controlled and/or feedback-controlled, particular preferably set and/or adjusted, by the control unit. The control unit can be assigned to the combination, in particular the towing vehicle or the baler or both together. The combination, in particular the towing vehicle or the baler or both together, can comprise the control unit. The control unit can also be designed as a towing vehicle control unit and/or baler control unit. The control unit can be assigned to the combination, in particular the towing vehicle or the baler or both together, and/or disposed on or in these. The control unit can be configured as an electronic module, an embedded system, a computing unit, a computer, as a module for controlling and/or feedback-controlling the combination, in particular the towing vehicle and/or the baler. The control unit can comprise a processor, a memory and/or all software, hardware, algorithms, connectors, in particular also sensors, which are necessary for controlling and/or feedback-controlling the combination. The method can be configured as a program or algorithm that can be executed on and/or by the control unit. The control unit can comprise any device that can analyze data from various sensors, compare data, and make the decisions necessary to control and/or feedback-control and/or perform the operation of the combination and the required tasks for controlling and/or feedback-controlling the operation of the combination. The control unit can be connected, preferably connected for signaling and/or connected for transmitting signals and/or conducting data, to the components of the combination, i.e. in particular the actuator and/or the further actuator(s) and/or the inclination sensor and/or the GPS installation and/or the steering installation and/or the steering actuator and/or the input and output unit and/or the detection installation and/or the image processing system and/or all other sensors, for example the bale sensor(s), wrapping sensors, ejection flap sensor and/or feedback sensors. A connection for signaling and/or transmitting signals and/or conducting data herein can be understood to mean inter alia that an exchange of signals or data takes place between the connected components. Signals can for example be received and transmitted, and/or processed and/or manipulated, by the control unit. The connection between the control unit and the components of the combination can be implemented so as to be wired, in particular thus with cables, and/or wireless, i.e. by radio, for example with Bluetooth or WLAN. The communications bus may for example be Isobus, CAN bus, or similar. Moreover, a further control unit can be able to be controlled and/or feedback-controlled and/or actuated by the control unit. The further control unit can be configured similarly to the control unit. The control unit can be assigned to the towing vehicle, in particular be disposed on the vehicle. The control unit can also be designed in two parts, for example as part of the vehicle and as part of the baler. The control unit may be connected directly to the input and output unit which is disposed in a cab of the vehicle and by means of which data entered by an operator can be transmitted to the control unit or received from the latter and emitted. It is however also conceivable for the control unit to be connected indirectly to the input and output unit by a superordinate control unit. The control unit can be integrated into the input and output unit or vice versa.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic illustration of a first exemplary embodiment of a combination of a towing vehicle and a baler.

FIG. 2 is a schematic illustration of the first exemplary embodiment of the combination from above.

FIGS. 3-5 are schematic illustrations of parts of the first exemplary embodiment of the combination.

FIG. 6 is a schematic flowchart of a method according to which the control unit of the device operates.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

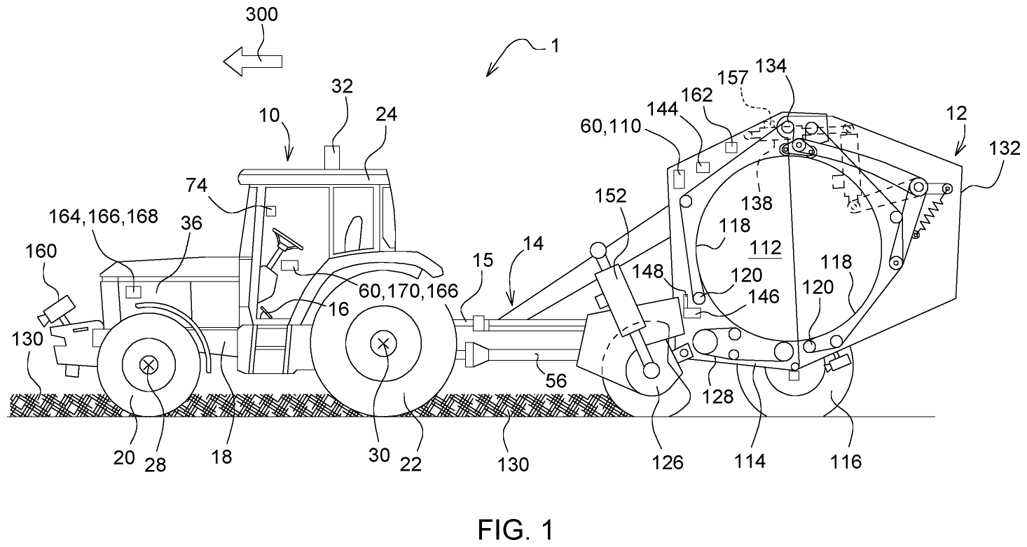

FIG. 1 shows a schematic illustration of a first exemplary embodiment of a combination 1 according to the disclosure, comprising a towing vehicle 10 and a baler 12 pulled by the towing vehicle 10 by means of a drawbar 14. The towing vehicle 10 can further comprise a drive motor 36. The drive motor 36 can moreover be connected to a drive shaft 56 of the baler 12. The combination 1 comprises an input and output unit 74 and a control unit 60, which are presently disposed in the towing vehicle. However, the control unit 60 can also be disposed so as to be distributed on or in the towing vehicle 10 and the baler 12. The drive motor 36 can be designed as an internal combustion engine or as an electric motor.

The combination 1 comprises an input and output unit 74 and a control unit 60, which are presently disposed in the towing vehicle 10. However, the control unit 60 can also be disposed so as to be distributed on or in the towing vehicle 10 and the baler 12. Likewise, the control unit 60 can be designed as a towing vehicle control unit 170 and baler control unit 110, wherein the baler 12 can comprise the baler control unit 110 and the towing vehicle 10 can comprise the towing vehicle control unit 170. The baler control unit 110 and the towing vehicle control unit 170 can each be individually designed as a control unit 60, or conjointly comprise the structure and all functionalities and all connections of the control unit 60. The control unit 60 is connected to the input and output unit 74, in particular connected for signaling. With the input and output unit 74 disposed in a cab 24 of the towing vehicle, data and/or commands entered by an operator of the combination 1 in the input and output unit 74 can be transmitted to or received from the control unit 60. Likewise, data and/or commands can be emitted by the input and output unit 74.

The towing vehicle 10 can comprise a towing vehicle frame 18, in particular can be supported on the towing vehicle frame 18. The towing vehicle frame 18 can be supported on ground engagement means. The ground engagement means, shown here in the form of front wheels 20 and rear wheels 22, are engaged with a hard surface for transmitting drive forces, and/or the towing vehicle 10 is supported with these on the hard surface. The ground engagement means, in particular the front wheels 20 and rear wheels 22, can be steerable and/or movable. The cab 24 can be supported by the towing vehicle frame 18. Moreover, an operator's workstation and/or the input and output unit 74 can be situated in the cab 24. The towing vehicle 10 comprises a front axle 28 and a rear axle 30. The rear axle 30 can be driven permanently and the front axle 28 cannot be driven or can be driven in an activatable manner or permanently as required. The front axle 28, and/or in particular the rear axle 30 can be able to be steered, in particular be able to be set and/or adjusted by a steering installation 164, particularly preferably by a steering actuator 168. The towing vehicle 10 can also comprise, for example, an accelerator pedal 16 or a hand throttle lever not shown. Directional details, such as front and rear, left and right, hereunder refer to the forward direction 300 of the towing vehicle 10, which forward direction goes to the left in FIG. 1.

The baler 12 is connected, and/or in particular coupled, to the towing vehicle 10. The towing vehicle 10 is connected to the baler 12 by the drawbar 14. For example, the baler 12 can be coupled by the drawbar 14 to a hitch 15 of the towing vehicle 10. The towing vehicle 10 can pull the baler 12. The baler 12 comprises a pick-up unit 126 for picking up crop, and a bale chamber 112 in order to form or compress the picked-up crop into a bale. In particular, the baler 12 can comprise a baler control unit 110 which is connected to the control unit 60, preferably connected for signaling. The baler 12 can comprise a baler frame 114. The baler frame 114 can be supported on wheels 116. The bale chamber 112 can be disposed at or on the baler frame 114, preferably connected to the latter and/or fastened to the latter and/or carried.

The baler 12 is designed with a variable-size bale chamber 112, or as a baler 12 with a variable bale chamber 112. The pressing means 118 is designed as a band or belt. The pressing means 118 surrounds the bale chamber 112 and is guided by rollers 120. However, the baler 12 can also comprise a size-invariable bale chamber. In this instance, the pressing means 112 can be designed as one or a plurality of pressing rollers, in particular a multiplicity of pressing rollers running parallel to one another, for compressing the crop.

The pick-up unit 126, in particular in the form of a pick-up, is disposed on the baler 12 and/or connected thereto, in particular below the front edge of the baler 12. The pick-up unit 126 can comprise tines moving or rotating about a transverse axis. The pick-up unit 126 can be followed in a crop flow direction by a conveyor unit, presently a conveyor belt 128, of the baler 12. The conveyor belt 128 could also be replaced by a rotor (not shown), or a rotor could be inserted in the crop flow direction between the pick-up unit 126 and the conveyor belt 128. Instead of the pick-up unit 126, in particular the pick-up, other suitable crop pick-up means, such as mowing and conveying units, could also be used.

The pick-up unit 126 collects crop that is lying in the field in a swath 130 of grass, hay or straw, for example, and feeds the crop to the bale chamber 112. The pressing means 118, in particular one or a plurality of bands or straps, can be set in motion in the longitudinal direction thereof during a baling process in that one or a plurality of the rollers 120 is/are rotatingly driven. The crop introduced into the bale chamber 112 therefore also rotates during the pressing. During the pressing procedure, the size of the bale chamber 112 increases over time.

The baler 12 can comprise an ejection unit 132, for example an ejection flap or a rear part or a tailgate of the baler. The ejection unit 132 can be pivotably disposed on the baler 12, in particular the baler frame 114 or a housing part, preferably be connected to the latter and/or fastened to the latter and/or supported. The ejection unit 132 can be pivotable about an axis 134 which extends transversely to the forward direction of the towing vehicle 10 and/or the longitudinal central axis of the baler 12.

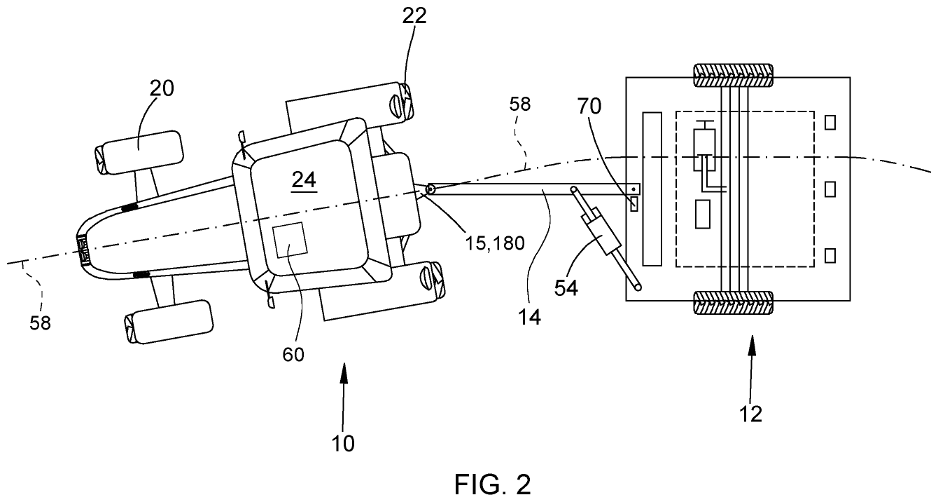

The control unit 60 is connected to an actuator 54 (see FIG. 2). The control unit 60 can be connected in particular via a valve assembly 180 (see FIG. 2), in particular a first valve assembly, for example via an electromagnetic or a hydraulic valve assembly, to the actuator 54. The actuator 54 is specified for setting and/or adjusting an angle between the drawbar 14 and the baler 12 so that the baler 12 is able to be steered in the lateral direction in relation to the towing vehicle 10 by the actuator 54.

A further or second actuator 138 in the form of a hydraulic cylinder, by way of one end, can be connected to the baler frame 114, and, by way of a second end, be connected to the ejection unit 132, in particular be fastened thereto and/or assembled thereon. The further actuator 138 can be connected to the ejection unit 132 in such a manner that it can pivot the ejection unit 132 upward about the axis 134 (counterclockwise in FIG. 1) in order to be able to eject a bale from the bale chamber 112. The ejection unit 132 can thus be opened or closed or raised and lowered by the further actuator 138. The further actuator 138 can be set and/or adjusted, in particular controlled and feedback-controlled, by the control unit 60 or the baler control unit 110 by or by way of the valve assembly 180 or a further or second valve assembly (not shown), for example by way of an electromagnetic or a hydraulic valve assembly. The further valve assembly herein can be set and/or adjusted, in particular controlled and feedback-controlled, by the control unit 60 or the baler control unit 110. For example, an ejection flap sensor 157 can detect the position of the further actuator 138 or of the ejection unit 132.

The ejection unit 132 of the baler 12 can be able to be controlled with the control unit 60 such that the bale is ejected when the unloading angle EW and/or the unloading position is set, in particular the combination 1 has reached the unloading position and the unloading angle EW is set. Moreover, a confirmation signal can be able to be generated by means of or by the control unit 60, when the unloading angle EW is set or the combination 1 has reached the unloading position and the unloading angle EW is set. The confirmation signal can be able to be sent from the control unit 60 to the input and output unit 74 and can be able to be emitted by the input and output unit 74. An ejection signal can likewise be able to be generated and transmitted to the control unit 60 by means of or by the input and output unit 74. The control unit 60 can then, as a function of the ejection signal, control the ejection unit 132 in such a manner that the bale is ejected when the unloading position and/or the unloading angle EW is set, in particular the combination 1 has reached the unloading position and/or the unloading angle EW is set.

The baler 12 can comprise a bale sensor 144 to detect the size of the bale in the bale chamber 112, or by way of which a size of a bale is detected. The control unit 60 or the baler control unit 110 can be connected to the bale sensor 144, preferably connected for signaling and/or transmitting signals and/or conducting data. The control unit 60 or the baler control unit 110 can be connected to the bale sensor 144 for example by means of a cable, in particular by way of a releasable plug, or via a radio connection. The bale sensor 144 can be disposed on or in the bale chamber 112, in particular fastened in the latter. The bale sensor 144 can detect, for example, the distance from the bale surface or from the pressing means 118 resting against the bale surface, and in this way can provide information about the size of the bale, in particular the radius and/or the bale diameter. The size of the bale sensed by the bale sensor 144 or the bale shape can be displayed to the operator on the input and output unit 74.

The baler can comprise a wrapping installation 146. The wrapping installation 146 can be disposed on, in particular in the vicinity of, the bale chamber 112. The wrapping installation 146 can be connected to the control unit 60 or the baler control unit 110 and, as soon as it is instructed in this regard by the control unit 60 or the baler control unit 110, can dispense a wrapping material, such as twine, a band, mesh or a packaging sheet, to the bale chamber 112. The rotating bale can pull on the wrapping material or trap same such that it is then wrapped around the bale. A wrapping sensor 148 can interact with the wrapping installation 146 and detect, for example, whether the bale pulls on the wrapping material and/or the wrapping procedure is completed and/or determine the status of the wrapping procedure.

The pick-up unit 126 can be raised and lowered, for example by a further or third actuator 152, here in the form of a hydraulic cylinder. The further actuator 152 can be set and/or adjusted, in particular controlled and feedback-controlled, by the control unit 60 or the baler control unit 110, for example via the valve assembly 180 or a further or third valve assembly (not illustrated). The further valve assembly can be, for example, a hydraulic or electromagnetic valve assembly. The further valve assembly can be set and/or adjusted, in particular controlled and feedback-controlled, by the control unit 60 or the baler control unit 110.

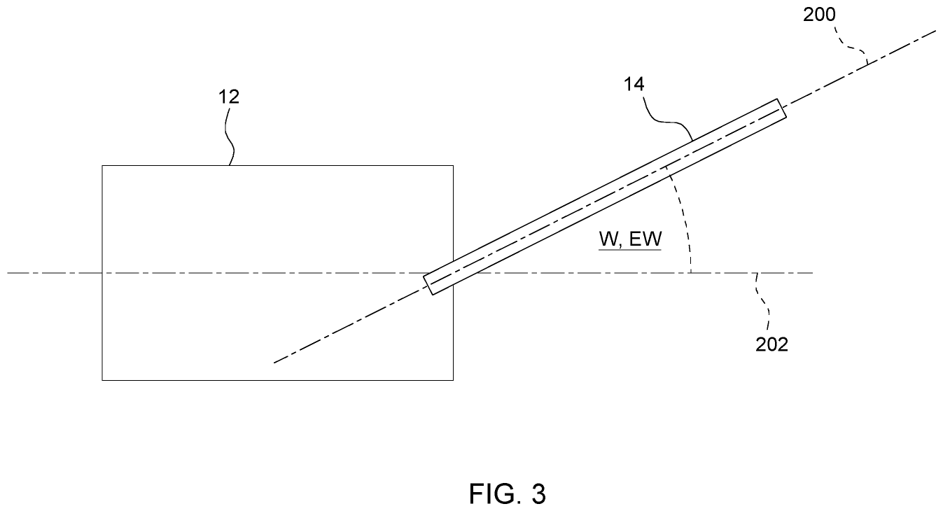

The combination 1, preferably the towing vehicle 10, can comprise a detection installation 160, here designed as a camera. The detection installation 160 can be assembled on the front side of the towing vehicle 10, as shown. The detection installation 160 is directed at the swath 130. The detection installation 160, or the camera, delivers a detection signal or a video signal to the control unit 60 or an image processing system (not shown). The detection signal or video signal can be processed in the image processing system. The image processing system can be designed in particular as part of the control unit 60, so as to provide electronic information about the position of the towing vehicle 10 with respect to the swath 130. The image processing system can moreover determine a target line of the swath 130, in particular a longitudinal central axis of the swath 206 (see FIGS. 3 to 5). Likewise, the image processing system can send a steering signal to the steering controller of the combination 1, and/or the control unit 60 or the control unit 60 and/or the steering controller can receive the steering signal. However, the steering signal can be produced or generated by the control unit 60 with, or as a function of, the detection signal or the target line of the swath.

The combination 1, in particular the baler 12, comprises an inclination sensor 162 for detecting the inclination of the combination 1 in the form of an inclination signal. The control unit 60 is connected to the inclination sensor 162 and receives the inclination signal from the inclination sensor 162. The control unit 60 is able to be operated in such a manner that the unloading angle EW and/or the unloading position are/is able to be determined and/or evaluated by the control unit 60 as a function of the inclination signal, in particular in such a manner that the inclination is compensated.

The combination 1, in particular the towing vehicle 10, can also comprise a GPS installation 32 for determining the position of the combination 1 in the form of a position signal. The control unit 60 is connected to the GPS installation 32. The control unit 60 receives the position signal from the GPS installation 32. The control unit 60 is able to be operated in such a manner that an unloading angle EW and/or an unloading position are/is able to be determined and/or evaluated by the control unit 60 as a function of the position signal. Thus, position data can be able to be sent and/or received, and/or in particular calculated, by the GPS installation 32. For example, the GPS installation 32 can comprise a GPS antenna, which receives position data, and a memory. The position of the swath 130 that is known from earlier jobs can be stored in the memory. The towing vehicle 10 can then be steered so that the actual position of the combination 1 or the towing vehicle 10, which are provided by the GPS antenna, and the position of the swath 130 from the memory match. Steering data could also be calculated by the baler control unit 110 or by a steering controller 166.

The combination 1 comprises a steering installation 164. The control unit 60 is connected to the steering installation 164. The steering installation 164 is able to be actuated by the control unit 60 as a function of the unloading signal in such a manner that the combination 1, in particular the towing vehicle 10, is able to be steered by the steering installation 164 to the unloading position. A steering controller 166 or the control unit 60 can actuate, in particular set and/or adjust, the steering installation 164, in particular the steering actuator 168 of the steering installation 164, the ground engagement means, in particular the steerable front wheels of the towing vehicle, in such a manner that the towing vehicle 10, in particular the longitudinal central axis 58 of the towing vehicle 10, as a function of the steering signal is guided at least approximately on the target line of the swath 130, the latter corresponding to the longitudinal central axis of the swath 206 (see FIGS. 3 to 5). Likewise, the steering installation 164, in particular the steering actuator 168, by way of the steering controller 166 and/or the control unit 60 of the ground engagement means, in particular the steerable front wheels 20 of the towing vehicle, can be actuated, in particular set and/or adjusted, in such a manner that the combination 1, in particular the towing vehicle 10 and/or the baler 12, is able to be steered by the steering installation 164 as a function of the unloading signal to the unloading position. The unloading signal can be able to be generated by the input and output unit 74 and able to be transmitted to the control unit 60. Or else, the unloading signal can likewise be able to be generated by the control unit 60 before a pressing phase is completed, or when the pressing phase is completed, or during or before a wrapping phase is completed, or when the wrapping phase is completed.

FIG. 2 shows a schematic illustration of the first exemplary embodiment of the combination 1 according to the disclosure, in a view from above. The combination 1 shown in FIG. 2 corresponds substantially to the combination 1 shown in FIG. 1, so that only details and/or differences will be discussed hereunder. The combination 1 shown in FIG. 2 comprises the actuator 54 which is connected to the control unit 60. The actuator 54 is able to be actuated by the control unit 60 as a function of an unloading signal, in such a manner that, in order to unload the bale, in particular the fully formed or fully wrapped bale from the baler 12 in a specified direction, an unloading angle EW between the drawbar 14 and the baler 12 is able to be set so that the bale can be ejected from the baler 12 in the specified direction, in particular at the unloading angle EW.

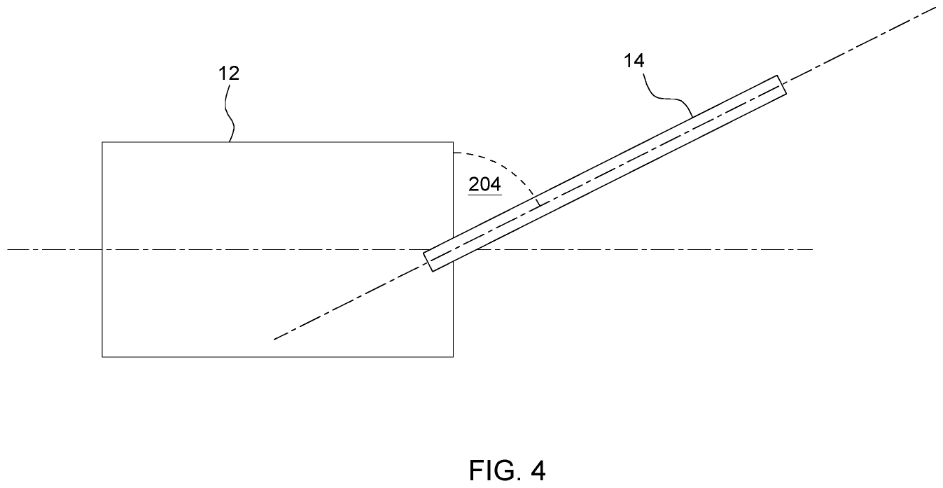

FIGS. 3 to 5 show schematic illustrations of the first exemplary embodiment of the combination 1 according to the disclosure, in particular the angles between the drawbar 14 and the baler 12. The combination 1 shown in FIGS. 3 to 5 corresponds substantially to the combination 1 shown in FIGS. 1 and 2, so that only details and/or differences will be discussed hereunder. The angle W or the unloading angle EW between the drawbar and the baler 12 can be evaluated or determined as the angle W or unloading angle EW between the longitudinal central axis 200 of the drawbar 14 and the longitudinal central axis 202 of the baler 10. According to FIG. 4, however, with the angle W or the unloading angle EW, the direct angle 204 between the baler 12 and the drawbar 14 can be evaluated as follows:

Angle₂₀₄=|90°−(W or EW)|

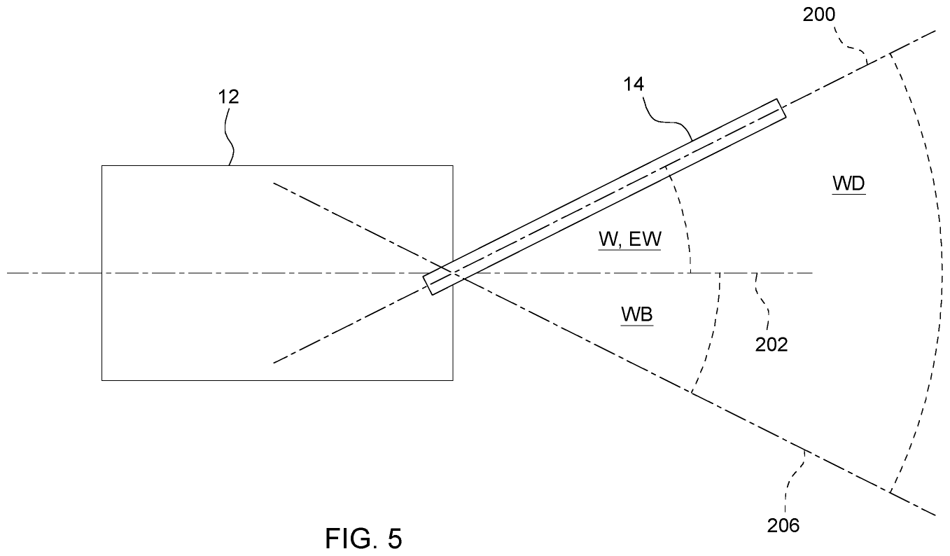

As shown in FIG. 5, the angle W or the unloading angle EW can however also be evaluated as a function of a target line of the swath 130 and subsequently be set and/or adjusted. The target line of the swath corresponds here to the longitudinal central axis 206 of the swath 130. The angle W or the unloading angle EW then results from the difference between the angle WB between the longitudinal central axis 202 of the baler 12 and the longitudinal central axis 206 of the swath 130 and between the longitudinal central axis 200 of the drawbar 14 and the longitudinal central axis 206 of the swath 130. Therefore:

$$EW = \vert WB - WD \vert$$

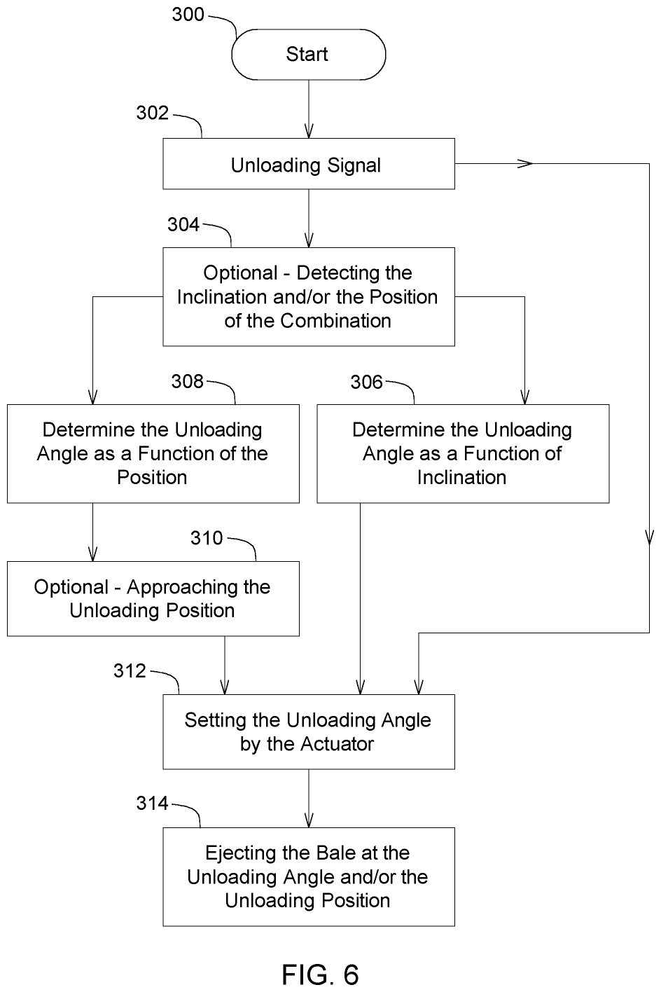

FIG. 6 shows a schematic flowchart of the method according to the disclosure, according to which the control unit 60 operates in particular and the progress of the method. The operating mode shown in FIG. 6 is able to be carried out with the combinations 1 shown in FIGS. 1 to 5. After starting in step 300, the step 302 follows, in which an unloading signal is generated. The unloading signal can be generated by the input and output unit 74 or the control unit 60. The unloading signal can be generated by the input and output unit 74, for example, by pressing a button or by a voice command. Then the unloading signal from the input and output unit 74 is transmitted, in particular sent, to the control unit 60. Alternatively, the unloading signal is generated by the control unit 60 before the pressing phase is completed, or when the pressing phase is completed, or during or before a wrapping phase is completed, or when the wrapping phase is completed. In the following step 304, an inclination of the combination 1, in particular the towing vehicle 10 and/or the baler 12, is optionally detected, in particular measured, in the form of the inclination signal. The inclination of the combination 1 can be detected, in particular measured, here by the inclination sensor 162 in the form of the inclination signal. Similarly, in step 304, a position of the combination 1, in particular the towing vehicle and/or the baler, can optionally be detected, in particular measured, in the form of the position signal. The position of the combination 1 here can be detected, in particular measured, by the GPS installation 32. In step 306, the unloading angle EW and/or the unloading position are/is optionally determined and/or evaluated, in particular calculated, as a function of or using the inclination signal or the inclination, respectively. In step 308, the unloading angle EW and/or the unloading position are/is optionally determined and/or evaluated, in particular calculated, as a function of or using the position signal or the position. The unloading angle EW can either be evaluated as a function of the inclination signal and/or the position signal or else can also be specified, for example, by an operator. In particular, the specified unloading angle EW can be a specified angle in relation to the target line of the swath at which the bale is to be deposited. If the unloading angle EW is specified, the operator can enter the unloading angle EW, for example, into the input and output unit 74 before step 300, for example by pressing a button or by a voice command, and the unloading angle EW is then transmitted, in particular sent, from the input and output unit 74 to the control unit 60. In this case, the steps 304 to 310 may be optional. If one or a plurality of steps 304 to 310 are carried out, the unloading angle EW can be evaluated, for example, in such a manner that the inclination of the combination 1, in particular the towing vehicle 10 and/or the baler 12, in particular the lateral inclination of the ground or a slope inclination, is compensated so that the bale does not roll down a slope. However, the unloading angle EW can also be evaluated or specified in such a manner that the specified angle in relation to a target line of the swath is maintained. The control unit 60 can then set and/or adjust the unloading angle EW. If one or a plurality of steps 304 to 310 are carried out, the unloading position can be evaluated in such a manner that the unloading position of the combination 1, in particular the towing vehicle 10 and/or the baler 12, is, for example, not on a slope or parallel to the slope, so that the bale does not roll down the slope, and/or an unloading position can be specified so that, for example, the bale can be optimally collected. The unloading position can also be evaluated or specified in such a manner that the specified unloading position is maintained, in particular also maintained in relation to a target line of the swath. The combination 1 can be controlled or steered to the unloading position as a function of the unloading signal or using the unloading signal. For this purpose, the combination 1 can comprise the steering installation 164, wherein the control unit 60 controls or steers the combination 1, in particular the towing vehicle 10, to the unloading position by the steering installation 164 as a function of the unloading signal. The control unit 60 of the combination 1, in particular the towing vehicle 10, can be moved or driven to the unloading position by the drive system as a function of the unloading signal. The combination 1, can then set and/or adjust, in particular approach, the unloading position, in particular by way of the control unit 60. For example, in order to compensate the inclination, the combination 1 can drive down or up the slope so as to place the combination 1 parallel to the slope in a self-acting manner prior to ejecting a bale, and to thus prevent that said combination rolls down the slope. In step 312, the unloading angle EW between the drawbar 14 and the baler 12 is set in such a way that the bale can be ejected from the baler 12 at the unloading angle EW. For this purpose, the unloading angle EW can be set by the actuator 54 as a function of the unloading signal, so as to unload the fully formed or fully wrapped bale from the baler 12 in a specified direction. The unloading angle EW can be determined and set and/or adjusted as described in FIGS. 3 to 5. For this purpose, in step 312, the signals for the valve assembly 180 can be determined and transmitted, and the actuator can be set and/or adjusted. In step 314, the ejection unit of the baler is opened and the bale is ejected when the unloading angle EW is set or the combination 1 has reached the unloading position and the unloading angle EW is set. In particular, the ejection unit can be controlled by the control unit 60, in particular opened or moved to the second position for this purpose.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A baling combination comprising:
a towing vehicle;
a baler drawn by the towing vehicle via a drawbar connecting the towing vehicle and the baler;
an actuator coupled to the drawbar and one of the towing vehicle and the baler, wherein the actuator is operable to adjust and angle between the drawbar and the baler;
a controller including a processor and a memory having an algorithm stored thereon, wherein the processor is operable to execute the algorithm to control the actuator as a function of an unloading signal to achieve a desired unloading angle between the drawbar and the baler, whereby a bale may be unloaded from the baler in a specified direction.

2. The baling combination set forth in claim 1, further comprising an inclination sensor for detecting an inclination of the baler in the form of an inclination signal, wherein the controller is connected to the inclination sensor for receiving the inclination signal from the inclination sensor, and wherein the controller is operable to define the unloading angle based on the inclination signal.

3. The baling combination set forth in claim 1, further comprising a Global Positioning Satellite (GPS) system for determining a position of one of the towing vehicle and the baler in the form of a position signal, wherein the controller is connected to the GPS system for receiving the position signal from the GPS installation, and wherein the controller is configured to define the unloading angle based on the position signal.

4. The baling combination set forth in claim 1, further comprising a steering installation, wherein the controller is connected to the steering installation for controlling the steering installation as a function of the unloading signal so as to control the steering installation in such a manner that the towing vehicle is moved to an unloading position by the steering installation.

5. The baling combination set forth in claim 1, further comprising an input and output unit, wherein the controller is connected to the input and output unit, and wherein the unloading signal is able to be generated by the input and output unit and transmitted to the controller.

6. The baling combination set forth in claim 1, wherein the unloading signal is generated by the controller at one of: before a pressing phase of the baler is completed, when the pressing phase of the baler is completed, before a wrapping phase of the baler is completed, or when the wrapping phase of the baler is completed.

7. The baling combination set forth in claim 1, wherein the controller is operable to actuate an ejection unit to eject the bale when the unloading angle and an unloading position are set.

8. The baling combination set forth in claim 1, wherein the towing vehicle includes an input and output unit connected to controller, wherein the input and output unit is operable to communicate a confirmation signal to the controller when the unloading angle or an unloading position are set.

9. The baling combination set forth in claim 1, wherein the towing vehicle includes an input and output unit connected to the controller, wherein the input and output unit is operable to generate an ejection signal to control an ejection unit to eject the bale.

10. A method of operating a baling combination including a towing vehicle and a baler pulled by the towing vehicle via a drawbar, wherein an angle between the drawbar and the baler is set by an actuator, wherein, for unloading a fully formed bale from the bale in a specified direction, an unloading angle between the drawbar and the baler is defined by a controller which controls the actuator as a function of an unloading signal in such a way that the bale is ejected from the baler at the unloading angle.

11. The method set forth in claim 10, wherein an inclination of the baling combination is detected in the form of an inclination signal, and the unloading angle (EW) and/or an unloading position are/is determined and/or evaluated by the controller as a function of the inclination signal.

12. The method set forth in claim 10, wherein the position of the baling combination is detected in the form of a position signal from a GPS sensor, and the unloading angle and/or an unloading position are/is determined by the controller as a function of the position signal.

13. The method set forth in claim 11, wherein the baling combination includes a steering installation, and wherein the method includes the controller operating the steering installation to move the baling combination to the unloading position as a function of the unloading signal.

14. The method set forth in claim 10, wherein the unloading signal is generated before one of a pressing phase has been completed, when the pressing phase is completed, before a wrapping phase is completed, or when the wrapping phase is completed.

15. A baler comprising:
a frame
a drawbar connected to the frame and configured for attachment to a towing vehicle whereby the towing vehicle may pull the frame;
an actuator interconnecting the frame and the drawbar and configured for adjusting an angle between the frame and the drawbar;
a controller connected to the actuator, and configured to control the actuator as a function of an unloading signal so as to actuate the actuator in such a manner that, for unloading the fully pressed bale from the baler in a specified direction, an unloading angle (EW) between the drawbar and the baler is defined by the controller in such a way that the bale is able to be ejected from the baler in the specified direction.
